(19) United States
(12) Patent Application Publication
(10) Pub. No.: US 2004/0088610 A1
(43) Pub. Date: May 6, 2004

(54) Apparatus for processing signal using minimum mean square error algorithm

(76) Inventor: Shuji Kobayakawa, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/279,962

(22) Filed: Oct. 24, 2002

(30) Foreign Application Priority Data
Nov. 2, 2001 (JP) 2001-337339

(51) Int. Cl. G06F 17/10; G06F 11/00

(52) U.S. Cl. 714/701

(57) ABSTRACT

Multipliers multiply corresponding input signals X1(n)˜Xm(n) by adaptive weights W1(n)˜Wm(n). An adder adds the output of the multipliers. The error function generating unit computes an error function e(n) indicating the difference between a sum Y(n) and a reference signal r(n). The adaptive weight update unit 4 computes the next adaptive weights W1(n+1)˜Wm(n+1) based on the error function e(n). The error function generating unit 3 includes a correction factor generation unit for generating correction factors α(n) and β(n) based on the adaptive weights W1(n)˜Wm(n), an arithmetic unit for multiplying the sum Y(n) by the correction factor β(n), an arithmetic unit for multiplying the reference signal r(n) by the correction factor α(n), and a subtracter 14 for computing the difference between output of the arithmetic units.

### BACKGROUND OF THE INVENTION

1. Field of the Invention

The present invention relates to an apparatus and a method for processing a signal using a minimum mean square error algorithm, and more specifically to a receiving device and a receiving method for processing a radio signal using the minimum mean square error algorithm.

2. Description of the Related Art

The minimum mean square error (MMSE) algorithm is a feedback control method for estimating a weight such that the difference between a weighted input signal and a reference signal (that is, a square of error) can be minimized, and is used in various fields to improve the quality of an input signal. Practically, for example, it is used in a device for receiving a radio signal, a device for analyzing voice, etc.

FIG. 1 shows the configuration of an adaptive array receiver using an existing minimum mean square error algorithm. An adaptive array receiver is provided in, for example, a base station of a wireless communications system, and forms a desired beam pattern to remove or suppress the interference between users (or between channels).

The adaptive array receiver shown in FIG. 1 comprises a plurality of antennas 101-1˜101-M. The signals received by the antennas 101-1˜101-M are converted into digital signals in the reception circuits 102-1˜102-M. The digital signals in the respective branches are complex numbers indicating the amplitude and the phase of the signals received by the corresponding antennas, and are referred to as branch signals X1(n)˜Xm(n). Here, “(n)” indicates the timing. For example, “n+1” indicates the next timing of the “n”.

Multipliers 1-1˜1-M multiply branch signals X1(n)˜Xm(n) by adaptive weights W1(n)˜Wm(n) generated by an adaptive weight update unit 104. An adder 2 adds the outputs of the multipliers 1-1˜1-M to obtain a sum Y(n). Here, the sum Y(n) is an output of this adaptive array receiver, and indicates the combined received signal. A subtracter 105 generates an error signal e(n) indicating the difference between the sum Y(n) output from the adder 2 and a reference r(n). A power detection unit 103 detects a total power of the branch signals X1(n)˜Xm(n).

The adaptive weight update unit 104 generates the next adaptive weights W1(n+1)˜Wm(n+1) such that the error function e(n) can be minimized based on the branch signals X1(n)˜Xm(n), the total power of the branch signals X1(n)˜Xm(n), and the error function e(n). The adaptive weights W1(n)˜Wm(n) are generated by the following equation (1). The definition used in the equation (1) is as follows.

Wk(n): the n-th adaptive weight in a branch k

μ: step constant

e(n): the n-th error function

Xk(n): the n-th branch signal in the branch k

M: number of branches

$${W}_{K} ( n + 1 ) = {W}_{K} ( n ) + μ \cdot \frac{e ( n ) {X}_{k}^{*} ( n )}{{\sum }_{k = 1}^{M} {\vert {X}_{k} ( n ) \vert}^{2}} \qquad ( 1 )$$

As shown in this equation (1), the next adaptive weight Wₖ(n+1) can be obtained by adding a correction value to the current adaptive weight Wₖ(n). The correction value is the amount of change in adaptive weight, and can be obtained from the error function e(n), the branch signal Xₖ(n), the total power of the branch signal Xₖ(n). The adaptive weight is updated at any time such that the error function e(n) can converge into zero.

In the equation (1) above, the value of the denominator in the second term of the right side indicates the power of a received signal. Therefore, the amount of change in adaptive weight is small when the power of a received signal is large in this algorithm, and the amount of change in adaptive weight is large when the power of a received signal is small in this algorithm. By automatically adjusting the amount of change in adaptive weight depending on the input level, an abnormal operation of the algorithm (the state in which an adaptive weight becomes zero, the state in which the adaptive weight Wₖ(n) is diverged, etc.) can be avoided. This system is commonly referred to as an NLMS (normalized least mean square).

As described above, the adaptive array receiver using the minimum mean square error algorithm converges an error function using the NLMS, etc.

However, in the equation (1) above, since the amount of change in adaptive weight is controlled by one parameter (power of a received signal), the error function e(n) does not duly converge in some methods of generating the reference signal r(n), and then the adaptive weight Wₖ(n) becomes an inappropriate value. For example, when the reference signal r(n) is generated according to a received signal with fading taken into account, it is probable that the error function e(n) does not converge. In addition, it is common that the above mentioned process of generating an adaptive weight is performed in a digital arithmetic operation, but multiplying an input signal by a weight becomes insignificant when an adaptive weight value exceeds the upper limit of a bit limit width or when it is too small to obtain a predetermined precision.

Thus, when an appropriate adaptive weight cannot be obtained, an error rate becomes higher in a communication system, and sometimes a communications service cannot be offered.

This problem occurs not only with the adaptive array receiver, but also with a calibrator for correcting the deviation of amplitude and phase by a nonlinear device of each antenna branch.

### SUMMARY OF THE INVENTION

The present invention aims at realizing a stable converging operation with a device for processing a signal using the minimum mean square error algorithm.

The signal processing device according to the present invention is based on the configuration in which a signal is processed using the minimum mean square error algorithm, and includes: an error function generation unit for generating an error function which indicates the difference between an output signal obtained by multiplying an input signal by an adaptive weight and a reference signal; a weight generation unit for generating the adaptive weight based on the error function generated by the error function generation unit; and a correction unit for correcting at least one of the output signal and the reference signal.

With this configuration, an output signal or a reference signal is corrected by the correction unit. Therefore, an error function used when an adaptive weight is generated can be easily controlled to be a desired value, thereby preventing the adaptive weight from converging into zero and diverging.

The signal processing device according to another aspect of the present invention includes in addition to the error function generation unit and the weight generation unit: a holding unit for holding an adaptive weight by which an input signal is multiplied; a determination unit for determining whether or not the adaptive weight generated by the weight generation unit satisfies a predetermined requirement; and a selection unit for outputting a newly generated adaptive weight by which a next input signal is multiplied when the adaptive weight newly generated by the weight generation unit satisfies the requirement, and outputting an adaptive weight which is held in the holding unit and by which the next input signal is multiplied when the newly generated adaptive weight does not satisfy the requirement.

With this configuration, an adaptive weight not satisfying the requirement is not used, thereby preventing the algorithm from becoming unstable.

The signal processing device according to a further aspect of the present invention includes in addition to the error function generation unit and the weight generation unit: an adjustment unit for adjusting an input timing of the output signal and the reference signal to the error function generation unit such that the adaptive weight generated by the weight generation unit can be optimized.

With this configuration, the reliability of the error function generated by the error function generation unit can be enhanced, thereby also enhancing the reliability of the adaptive weight generated based on the error function.

### BRIEF DESCRIPTION OF THE DRAWINGS

FIG. 1 shows the configuration of the adaptive array receiver using the existing minimum mean square error algorithm;

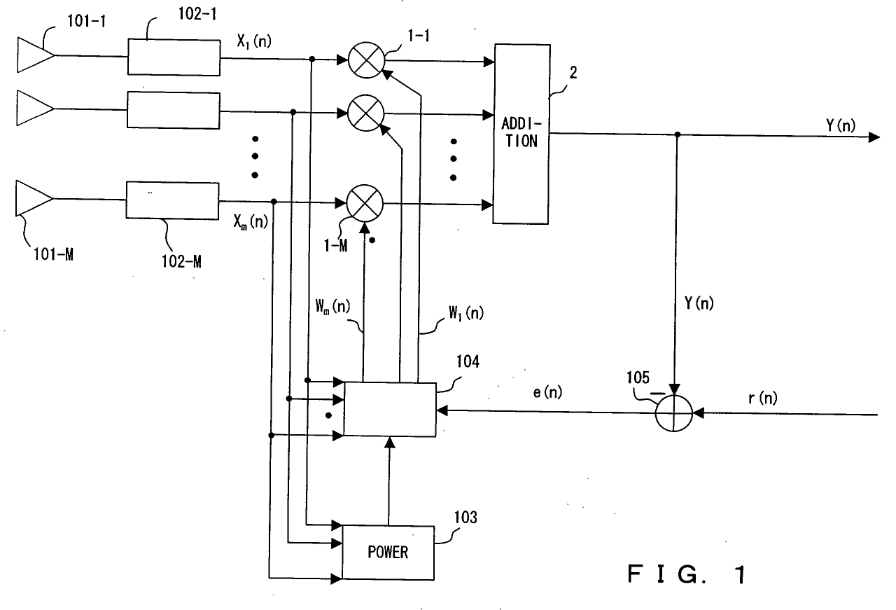

FIG. 2 shows the basic configuration of the present invention;

FIG. 3 shows the wireless communications system in which the signal processing device according to the present invention is used;

FIG. 4 shows the configuration of the base station provided with the signal processing device according to the present invention;

FIG. 5 shows the configuration of the adaptive array receiver according to an embodiment of the present invention;

FIG. 6 shows an example of a variation of the error function generating unit;

FIG. 7 shows the configuration of the adaptive array receiver according to another embodiment of the present invention;

FIGS. 8A and 8B show the operations of the arithmetic unit realized by a shift register;

FIG. 9 shows an embodiment of the correction factor generation unit;

FIG. 10 is a flowchart of the operation of the determination unit shown in FIG. 9;

FIG. 11 shows the configuration of the adaptive array receiver according to another embodiment;

FIG. 12 shows an embodiment of the correction factor generation unit shown in FIG. 11;

FIG. 13 is a flowchart of the operation of the determination unit shown in FIG. 12;

FIG. 14 shows an example of a variation of the adaptive array receiver shown in FIG. 11;

FIG. 15 shows the configuration of the adaptive array receiver according to another embodiment;

FIG. 16 shows an embodiment of the update control unit shown in FIG. 15;

FIG. 17 is a flowchart of the operation of the determination unit shown in FIG. 16;

FIG. 18 shows the function of setting the application range of an adaptive weight or reception level;

FIGS. 19A and 19B show the method of setting a threshold;

FIG. 20 shows the configuration of the error function generating unit having the timing adjusting capability;

FIG. 21 shows the operation (1) of the error function generating unit shown in FIG. 20;

FIGS. 22A and 22B show the operation (2) of the error function generating unit shown in FIG. 20;

### DESCRIPTION OF THE PREFERRED EMBODIMENTS

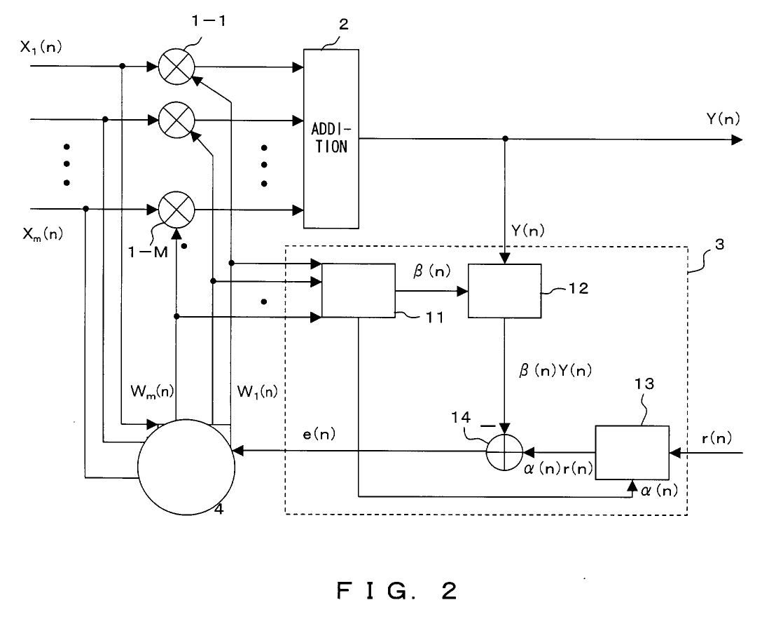

FIG. 2 shows the basic configuration of the present invention. The present invention is based on the apparatus and the method for processing a signal using a minimum mean square error algorithm.

The multipliers 1-1˜1-M multiply input signals X1(n)˜Xm(n) by the respective adaptive weights W1(n)˜Wm(n) generated by an adaptive weight update unit 4. The adder 2 adds the output signals (that is, the input signals X1(n)˜Xm(n) multiplied by the respective adaptive weights W1(n)˜Wm(n)) output from the respective multipliers 1-1˜1-M. An error function generating unit 3 generates an error signal e(n) according to the sum Y(n) output by the adder 2 and the reference signal r(n). The adaptive weight update unit 4 generates the next adaptive weights W1(n+1)˜Wm(n+1) such that the error function e(n) is minimized based on the input signals X1(n)˜Xm(n) before multiplication by the adaptive weights W1(n)˜Wm(n) and the error function e(n).

The error function generating unit 3 provided with a correction factor generation unit 11, an arithmetic units 12 and 13, and a subtracter 14. The correction factor generation unit 11 monitors the adaptive weights W1(n)˜Wm(n) generated by the adaptive weight update unit 4, and generates the correction factor α(n) for changing the reference signal r(n) and/or the correction factor β(n) for changing the sum Y(n). The arithmetic unit 12 changes the sum Y(n) using the correction factor β(n) when it is generated by the correction factor generation unit 11. On the other hand, when the correction factor generation unit 11 generates the correction factor α(n), the arithmetic unit 13 uses it in changing the reference signal r(n). The arithmetic unit 12 multiplies the sum Y(n) by the correction factor β(n), and the arithmetic unit 13 multiplies the reference signal r(n) by the correction factor α(n). Then, the subtracter 14 generates an error function e(n) indicating the difference between the output of the arithmetic unit 12 and the output of the arithmetic unit 13.

The adaptive weight update unit 4 generates the next adaptive weights W1(n+1)˜Wm(n+1) by the equation (2) below based on the input signals X1(n)˜Xm(n) which will be multiplied by the adaptive weights W1(n)˜Wm(n) and the error function e(n) generated by the error function generating unit 3. The definition used in the equation (2) is listed below.

Wk(n): the n-th adaptive weight in a branch k

μ: step constant

Xk(n): the n-th branch signal in the branch k

M: number of branches

r(n): the n-th reference signal

Y(n): ΣWk(n)·Xk(n) (where k=1 M)

α(n): correction factor for changing reference signal r(n)

β(n): correction factor for changing the sum Y(n)

$${W}_{k} ( n + 1 ) = {W}_{k} ( n ) + μ \cdot \{ α ( n ) r ( n ) - β ( n ) Y ( n ) \} \cdot \frac{{X}_{k}^{*} ( n )}{{\sum }_{k = 1}^{M} {\vert {X}_{k} ( n ) \vert}^{2}} \qquad ( 2 )$$

In this equation (2), “α(n) r(n)−β(n) Y(n)” corresponds to the error function e(n).

With the above mentioned configuration, the error function generating unit 3 monitors the adaptive weights W1(n)˜Wm(n), and adjusts the error function e(n) such that an appropriate value of an adaptive weight can be obtained by changing at least one of the reference signal r(n) and the sum Y(n) depending on the monitored values. The amount of change in adaptive weight is determined by controlling the reference signal r(n) or the sum Y(n), thereby allowing high flexibility, and preventing the adaptive weight from converging into an inappropriate value (zero, etc.).

In the equation (2) above, the input signal is normalized, but the present invention is not limited to this application.

Described below is an embodiment of the present invention. In the following embodiment, the present invention is applied to an adaptive array receiver provided in the base station of a wireless communications system.

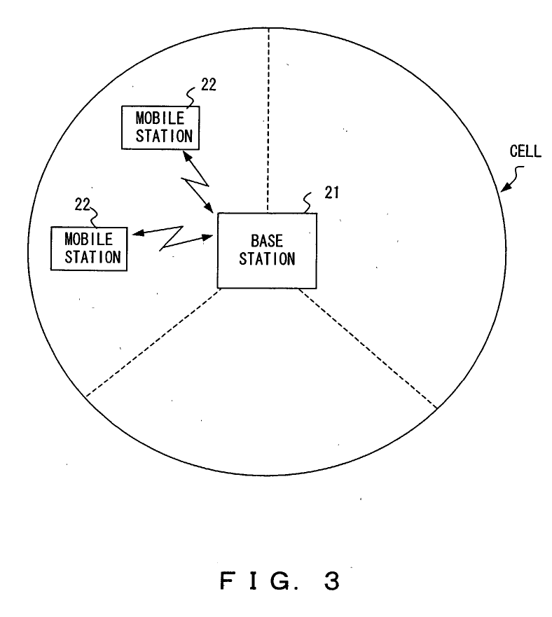

FIG. 3 shows the wireless communications system in which the signal processing device according to the present invention is used. The wireless communications system comprises a plurality of base stations 21. In FIG. 3, only one base station is shown. Each base station 21 manages a cell (communications area), and transmits and receives a radio signal to and from a mobile station 22 located in its own cell. Each cell is divided into a plurality of sectors for management. In the example shown in FIG. 3, each cell is divided into three sectors. Furthermore, the base station 21 is provided with an adaptive array receiver (or an adaptive array antenna) for each sector.

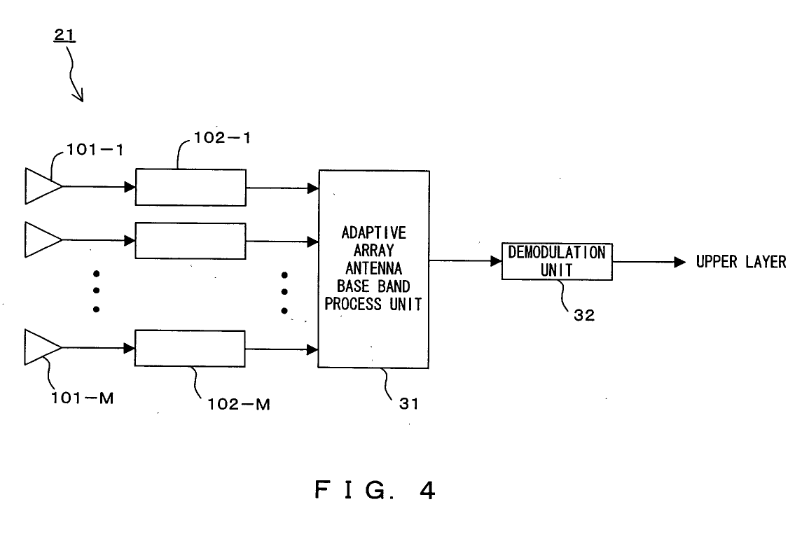

FIG. 4 shows the configuration of the base station 21 comprising the signal processing device according to the present invention. In FIG. 4, a transmitting circuit and an upper layer device are omitted.

The base station 21 is provided with an adaptive array receiver as described above. The adaptive array receiver comprises the antennas 101-1˜101-M for receiving a radio signal; the reception circuits 102-1˜102-M for converting the signals received by the antennas 101-1˜101-M into the respective digital signals; and an adaptive array antenna base band process unit 31 for extracting a desired signal from the outputs of the reception circuits 102-1˜102-M. Then, a demodulation unit 32 demodulates the output of the adaptive array receiver and passes the result to the upper layer device. In the base station 21 with this configuration, the signal processing device according to the present invention is provided in the adaptive array antenna base band process unit 31.

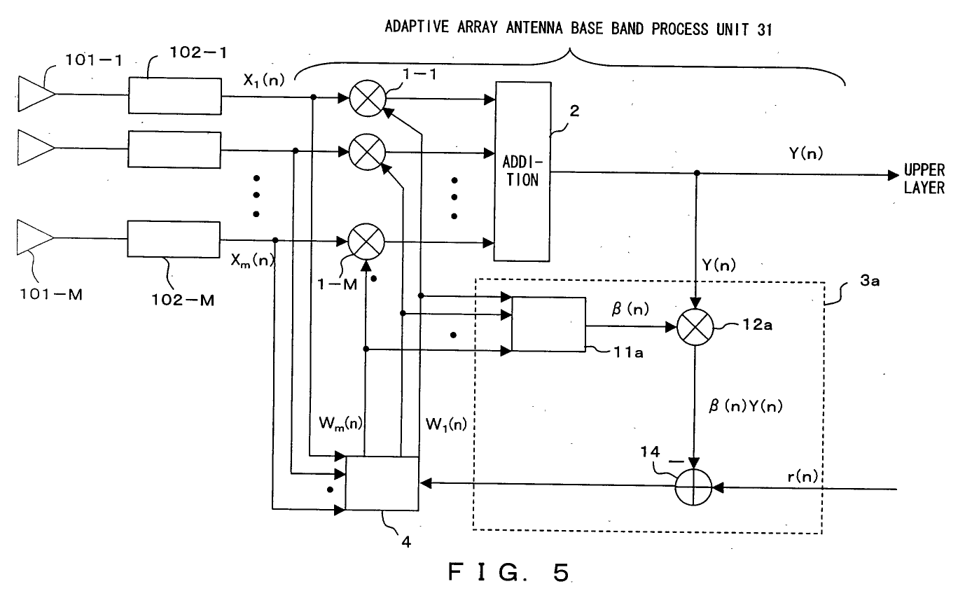

FIG. 5 shows the configuration of the adaptive array receiver according to an embodiment of the present invention. This adaptive array receiver is configured by, for example, the antennas 101-1˜101-M, the reception circuits 102-1˜102-M, and the adaptive array antenna base band process unit 31 shown in FIG. 4.

The adaptive array receiver is a wireless receiver provided with a plurality of antennas. After adding appropriate amplitude/phase shift to the signal received by each antenna, and adding up the results, the directionality can be controlled. The amplitude/phase shift is provided as a weight of a complex number adaptively computed for each branch. Therefore, in the base station of the wireless communications system, a beam pattern for removing or suppressing the interference between users can be formed.

The antennas 101-1˜101-M and the reception circuits 102-1˜102-M are described above by referring to FIG. 4. Each of the reception circuits 102-1˜102-M comprises: an RF amplifier for amplifying a received signal of a radio frequency area; a conversion circuit for converting the signal of the radio frequency area amplified by the RF amplitude into a signal of an intermediate frequency area; an AGC circuit for controlling the output level of the conversion circuit; an A/D converter for converting the output of the AGC circuit into digital data, etc. The output of the reception circuits 102-1˜102-M is the digital data of the complex number indicating the amplitude and phase of a received signal. That is to say, the phase of a received signal is indicated by a ratio of the real part to the imaginary part of a complex number, and the power of a received signal is indicated by a sum of squares of the real part and the imaginary part of the complex number. Hereinafter, a digital signal of each branch is referred to as the “branch signals X1(n)˜Xm(n)”.

The multipliers 1-1˜1-M, the adder 2, and the adaptive weight update unit 4 are described above by referring to FIG. 2. That is to say, the multipliers 1-1˜1-M multiply the branch signals X1(n)˜Xm(n) by corresponding adaptive weights W1(n)·Wm(n) generated by the adaptive weight update unit 4. The adder 2 adds the outputs of the multipliers 1-1˜1-M (that is, the branch signals X1(n)˜Xm(n) multiplied by the adaptive weights W1(n)˜Wm(n)). The adaptive weight update unit 4 generates the next adaptive weights W1(n+1)˜Wm(n+1) based on the branch signals X1(n)˜Xm(n) and the error function e(n) generated by an error function generating unit 3a.

The error function generating unit 3a comprises a correction factor generation unit 11a, an arithmetic unit 12a, and the subtracter 14. The correction factor generation unit 11a monitors the adaptive weights W1(n)˜Wm(n) generated by the adaptive weight update unit 4, and generates the correction factor β(n) for changing the sum Y(n) The arithmetic unit 12a is a multiplier, and multiplies the sum Y(n) by the correction factor β(n) generated by the correction factor generation unit 11a. Then, the subtracter 14 generates the error function e(n) by computing the difference between the output of the arithmetic unit 12a and the reference signal r(n). Therefore, the error function e(n) generated by the error function generating unit 3a is “r(n)−β(n) Y(n)”.

The adaptive weight update unit 4 generates the next adaptive weights W1(n+1)˜Wm(n+1) by the equation (2) above based on the branch signals X1(n)˜Xm(n) and the error function e(n) generated by the error function generating unit 3a. Here, with the configuration shown in FIG. 5, “α(n)=1” is assigned by the equation (2) above.

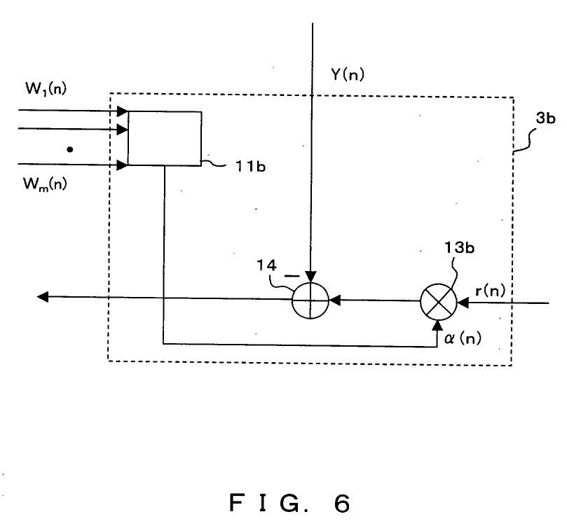

FIG. 6 shows an example of a variation of the error function generating unit. The error function generating unit 3b shown in FIG. 6 comprises a correction factor generation unit 11b, an arithmetic unit 13b, and the subtracter 14. The correction factor generation unit 11b generates the correction factor α(n) for changing the reference signal r(n) based on the adaptive weights W1(n)˜Wm(n). The arithmetic unit 13b is a multiplier, and multiplies the reference signal r(n) by the correction factor α(n) generated by the correction factor generation unit 11b. The subtracter 14 generates the error function e(n) by computing the difference between the output of the arithmetic unit 13b and the sum Y(n). Therefore, the error function e(n) generated by the error function generating unit 3b is “α(n) r(n)−Y(n)”.

The adaptive weight update unit 4 generates the next adaptive weights W1(n+1)˜Wm(n+1) by the equation (2) above based on the branch signals X1(n)˜Xm(n) and the error function e(n) generated by the error function generating unit 3b. Here, when the error function generating unit 3b shown in FIG. 6 is used, “β(n)=1” is assigned by the equation (2) above.

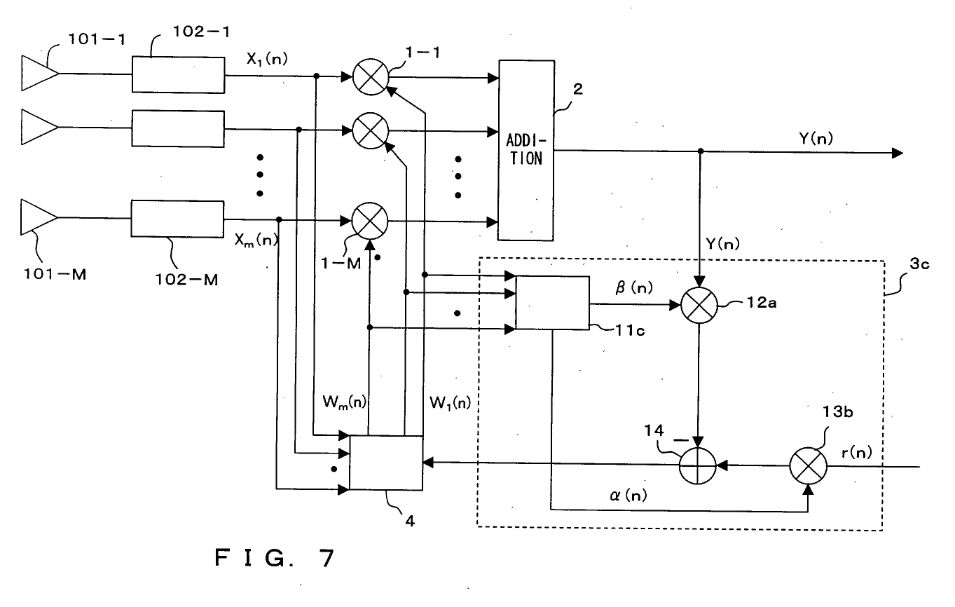

FIG. 7 shows the configuration of the adaptive array receiver according to another embodiment of the present invention. This adaptive array receiver has the similar configuration as that shown in FIG. 5, and generates the correction factor α(n) and the correction factor β(n) by which the reference signal and the sum Y(n) are multiplied, respectively. That is to say, the error function generating unit 3 shown in FIG. 7 comprises a correction factor generation unit 11c, the arithmetic units 12a and 13b, and the subtracter 14. The correction factor generation unit 11c generates the correction factor α(n) and the correction factor β(n). The arithmetic unit 12a multiplies the sum Y(n) by the correction factor β(n), and the arithmetic unit 13b multiplies the reference signal r(n) by the correction factor α(n). The subtracter 14 generates the error function e(n) by computing the difference between the output of the arithmetic unit 12a and the output of the arithmetic unit 13b. Therefore, the error function e(n) generated by the error function generating unit 3c is “α(n) r(n)˜β(n)·Y(n)”.

Thus, the adaptive array receiver shown in FIG. 7 corrects both of the sum Y(n) and the reference signal r(n) using a set of correction factors α(n) and β(n). Practically, the error function e(n) is represented by “α(n)·r(n)−β(n)·Y(n)”. Therefore, to obtain a larger error function e(n), the value of the correction factor α(n) can be larger, or the value of the correction factor β(n) can be smaller. On the other hand, to obtain a smaller error function e(n), the value of the correction factor α(n) can be smaller, or the value of the correction factor β(n) can be larger. Accordingly, although the number of bits of digital data indicating each correction factor is small, the dynamic range in computing the error function e(n) becomes larger, thereby correctly generating an appropriate adaptive weight.

A practical example is described below by comparing the configuration with that shown in FIG. 5 or 6. Each correction factor is assumed to be 4-bit digital data formed by one sign bit and 3 data bits. In this case, the ranges of the correction factors are limited to “1/7≦α(n) and β(n)≦7” respectively. Therefore, for example, with the configuration shown in FIG. 5, the range of the error function e is [“r(n)−7Y(n)”≦e(n)≦“r(n)−Y(n)/7”]. On the other hand, with the configuration shown in FIG. 7, the range of the error function e is [“r(n)/7−7Y(n)”≦e(n)≦“7r(n)−Y(n)/7”].

If the number of bits of digital data indicating a correction factor is increased, a large dynamic range can be obtained with the configuration shown in FIG. 5 or 6. However, if the number of bits of the correction factor is increased, the circuits of the arithmetic units 12 and 13 become larger.

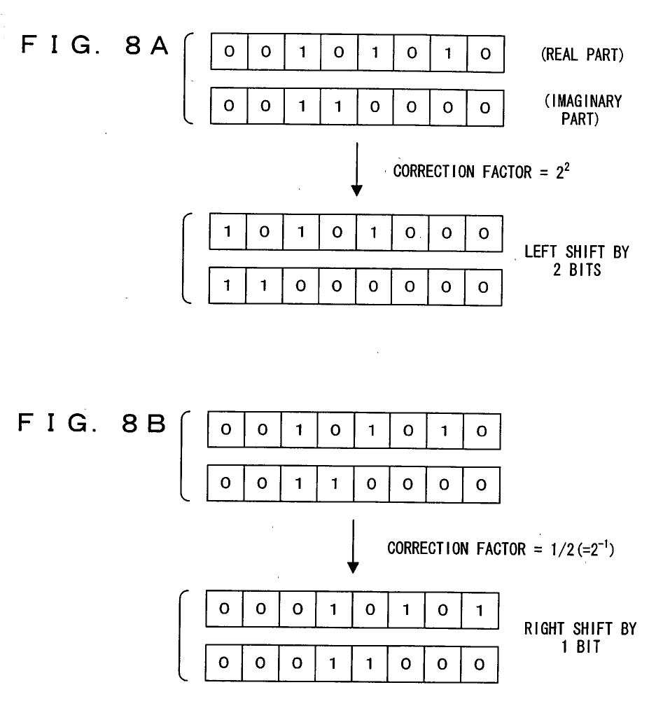

Although each correction factor can basically be a desired value, each of the arithmetic units 12 and 13 can be realized by a shift register if the value is limited to “2^{k} (k=0, ±1, ±2, ±3, . . . )”. Each of the sum Y(n) and the reference signal r(n) is a complex number. Therefore, each of the arithmetic units 12 and 13 is formed by a set of shift register storing a real part data and imaginary part data of a complex number. A set of the shift registers performs a bit shift operation according to a given correction factor. FIGS. 8A and 8B show the operations of a shift register when “k=2” and “k=−1” respectively. However, in this case, the digital data is formed by 8 data bits without a sign bit.

Thus, the value of each correction factor is limited to “2^{k} (k=0, ±1, ±2, ±3, . . . ) ”, the configurations of the arithmetic units 12 and 13 can be simple.

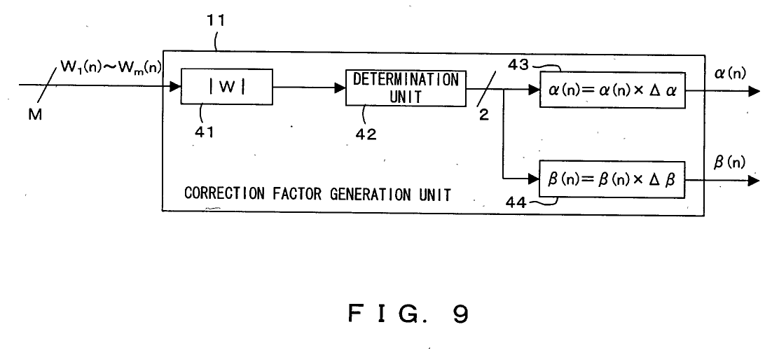

FIG. 9 shows an embodiment of the correction factor generation unit 11. The correction factor generation unit 11 generates the correction factor α(n) and the correction factor β(n) based on the adaptive weights W1(n)˜Wm(n) generated by the adaptive weight update unit 4.

An amplitude computation unit 41 obtains each amplitude by computing corresponding absolute value of the adaptive weights W1(n)˜Wm(n). Here, each of the adaptive weights W1(n)˜Wm(n) is a complex number, and the method for computing the absolute value is well known. A determination unit 42 checks whether or not each amplitude obtained by the amplitude computation unit 41 is in a predetermined range, and determines the amount of change in the correction factor based on the determination result. According to the amount of change determined by the determination unit 42, an update unit 43 updates the correction factor α(n), and an update unit 44 updates the correction factor β(n).

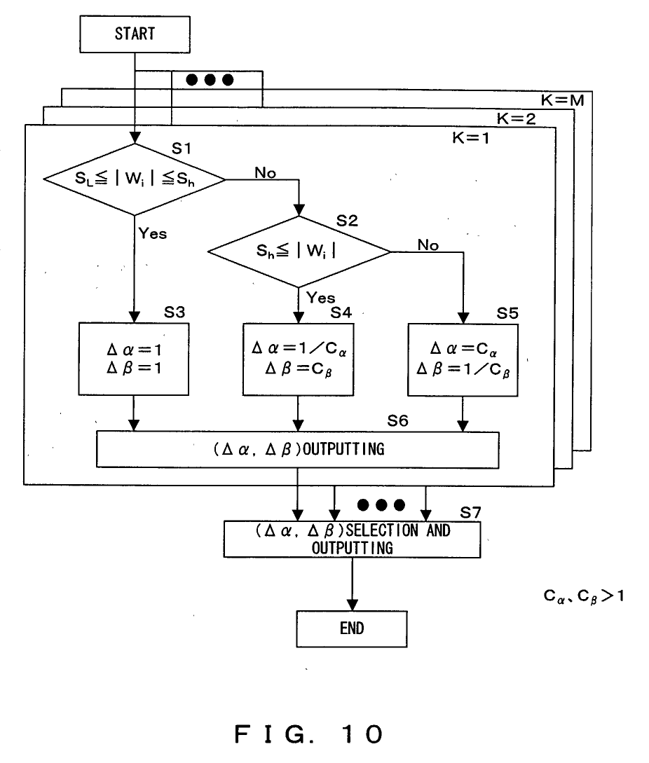

FIG. 10 is a flowchart of the operation of the determination unit 42 shown in FIG. 9. The process of this flowchart is performed each time a set of the adaptive weights W1(n)˜Wm(n) is generated. It is assumed that the amplitude computation unit 41 computes the amplitude of each of the adaptive weights W1(n)˜Wm(n). The processes in steps S1 through S6 are performed for each branch.

In steps S1 and S2, it is determined whether the amplitude of each of the adaptive weights W1(n)˜Wm(n) is in a predetermined amplitude range, smaller than the lower limit threshold SL of the range, or larger than the upper limit threshold Sh of the range. The amplitude range is the range in which convergence of an adaptive weight is guaranteed, and the lower limit threshold SL and the upper limit threshold Sh are obtained by a test, a simulation, etc.

If the amplitude of the adaptive weights W1(n)˜Wm(n) is in the above mentioned amplitude range, the amounts of changes Δα and Δβ of the correction factor are generated as “1” in step S3. In this case, the correction factors α(n) and β(n) output from the update units 43 and 44 are not changed.

When an adaptive weight having larger amplitude than the upper limit threshold Sh is contained, a predetermined value (1/Cα) is generated as an amount of change Δα, and a predetermined value (Cβ) is generated as an amount of change Δβ in step S4. Here, both of the “Cα” and “Cβ” are larger than 1, respectively. In this case, the correction factor α(n) is updated into a value smaller than the current value by the update unit 43, and the correction factor β(n) is updated into a value larger than the current value by the update unit 44.

On the other hand, when an adaptive weight having smaller amplitude than the lower limit threshold SL is contained, a predetermined value (Cα) is generated as an amount of change Δα in step S5, and a predetermined value (1/Cβ) is generated as an amount of change Δβ. In this case, the correction factor α(n) is updated into a value larger than the current value by the update unit 43, and the correction factor β(n) is updated into a value smaller than the current value by the update unit 44.

In step S6, the amounts of changes Δ≢ and Δβ generated for each branch are output. In step S7, the amounts of changes Δα and Δβ for each branch are collected, and the following electing process is performed. That is to say, when “(Δα, Δβ)=(1, 1)” is obtained in all branches, “(Δα, Δβ)=(1, 1)” is output. If “(Δα, Δβ)=(1/Cα, Cβ)” is contained, “(Δβ, Δβ)=(1/Cα, Cβ)” is output. On the other hand, if “(Δα, Δβ)=(Cα, 1/Cβ)” is contained, “(Δα, Δβ)=(Cα, 1/Cβ)” is output. Then, the selected “Δα, Δβ” is transmitted to the corresponding update units 43 and 44.

Thus, according to the correction factor generation unit 11 shown in FIG. 9, if the adaptive weight is in an appropriate range, the correction factor can be maintained as is. On the other hand, if it is determined that the adaptive weight is too large, each correction factor is updated such that the reference signal r(n) is made smaller, and/or the sum Y(n) is made larger. If it is determined that the adaptive weight is too small, each correction factor is updated such that the reference signal r(n) is made larger, and/or the sum Y(n) is made smaller.

If the amplitude values of one or more adaptive weights in the adaptive weights W1(n)˜Wm(n) are larger than the above mentioned upper limit threshold in the adaptive array receiver, then there is the smallest possibility that another adaptive weight can be smaller than the lower limit threshold. Similarly, if the amplitude values of one or more adaptive weights are smaller than the above mentioned lower limit threshold, then there is the smallest possibility that another adaptive weight can be larger than the highest limit threshold.

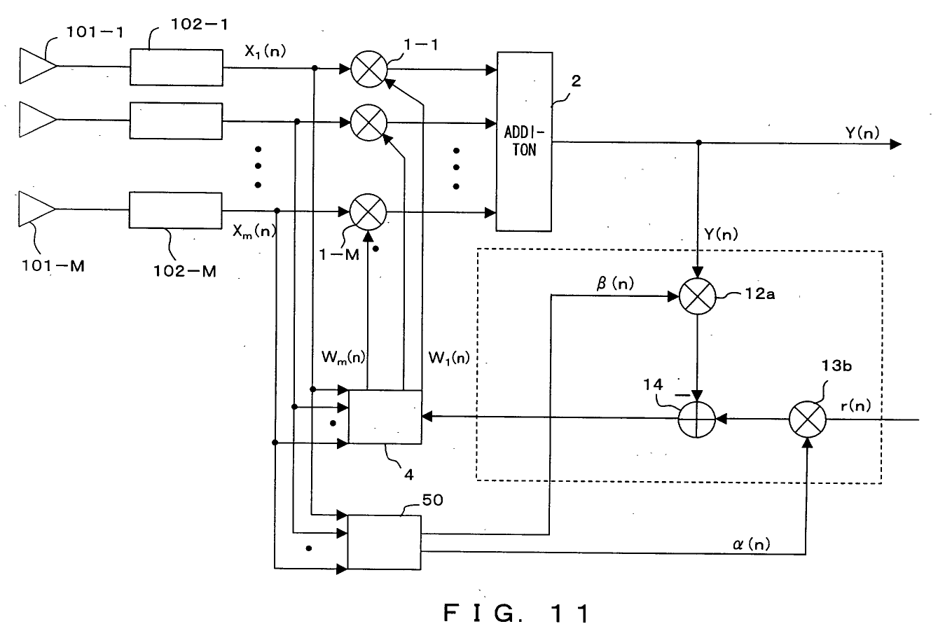

FIG. 11 shows the configuration of the adaptive array receiver according to another embodiment of the present invention. In the adaptive array receiver shown in FIGS. 2, 5, 6, and 7, the correction factor for changing the reference signal r(n) and the sum Y(n) are generated based on the adaptive weights W1(n)˜Wm(n) as described above. On the other hand, in the adaptive array receiver shown in FIG. 11, each correction factor is generated based on the branch signals X1(n)˜Xm(n). The embodiment is derived from the close relationship between the power of the branch signals X1(n)˜Xm(n) and the adaptive weights W1(n)˜Wm(n).

A correction factor generation unit 50 computes the power of each of the branch signals X1(n)˜Xm(n) before performing the multiplication by the corresponding adaptive weights W1(n)˜Wm(n), and generates the correction factors α(n) and β(n) based on the computation result. The explanation given by referring to FIGS. 5 through 7 can basically be applied to other configurations. That is to say, the arithmetic unit 12a multiplies the sum Y(n) by the correction factor β(n) generated by the correction factor generation unit 50. The arithmetic unit 13b multiplies the reference signal r(n) by the correction factor α(n) generated by the correction factor generation unit 50. Furthermore, the subtracter 14 provides the error function e(n) indicating the difference between them for the adaptive weight update unit 4. Here, the operation of the adaptive weight update unit 4 is described by referring to FIGS. 5 through 7, and generates an adaptive weight by the equation (2) above.

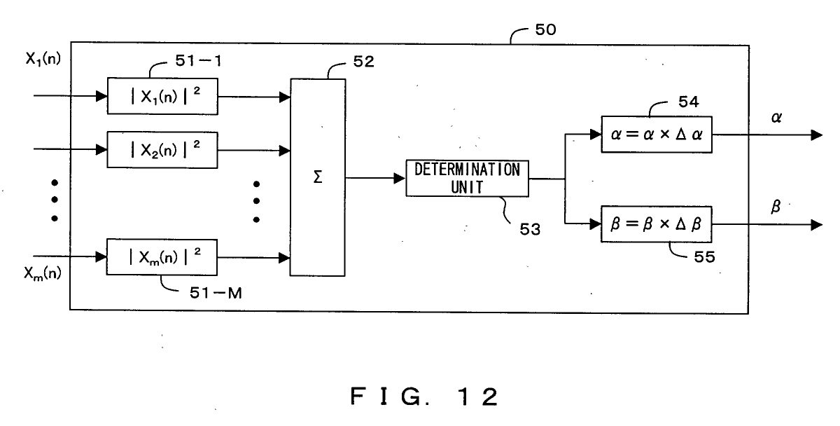

FIG. 12 shows an embodiment of the correction factor generation unit 50 shown in FIG. 11. The power detection units 51-1˜51-M compute the power of the branch signals X1(n)˜Xm(n) before performing multiplication by corresponding adaptive weights W1(n)˜Wm(n). Since each branch signal is a complex number, the power is obtained from the sum of squares of the value of the real part and the value of the imaginary part of the complex number. The power addition unit 52 computes the total power of the branch signals detected by the power detection units 51-1˜51-M.

A determination unit 53 determines the amount of change of the correction factor based on the total power of the branch signals detected by the power addition unit 52. According to the amount of change determined by the determination unit 53, an update unit 54 updates the correction factor α, and an update unit 55 updates the correction factor β.

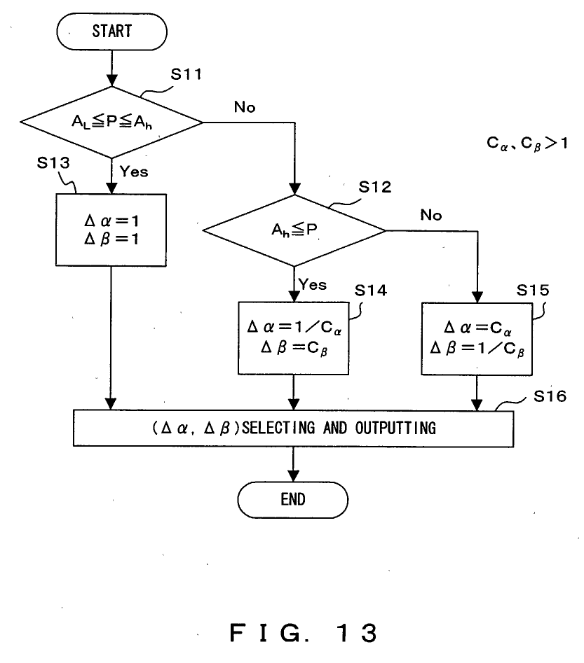

FIG. 13 is a flowchart of the operation of the determination unit 53. The process of this flowchart is performed each time a set of the branch signals X1(n)˜Xm(n) is input. In this example, the power addition unit 52 computes the total power P of the branch signals X1(n)˜Xm(n).

In steps S11 and S12, it is determined whether the total power P of the branch signals X1(n)˜Xm(n) is in a predetermined power range, smaller than the lower limit threshold AL of the range, or larger than the upper limit threshold Ah of the range. This power range is the range in which convergence of an adaptive weight is guaranteed, and the lower limit threshold AL and the upper limit threshold Ah are obtained by a test, a simulation, etc.

If the total power P of the branch signals X1(n)˜Xm(n) is in the above mentioned power range, the amounts of changes Δα and Δβ of the correction factor are generated as “1” in step S13. In this case, the correction factors α(n) and β(n) output from the arithmetic units 54 and 55 are not changed.

When the total power P is larger than the upper limit threshold Ah, a predetermined value “1/Cα (<1)” is generated as an amount of change Δα, and a predetermined value “Cα (>1)” is generated as an amount of change Δβ in step S14. In this case, the correction factor α(n) is updated into a value smaller than the current value by the update unit 54, and the correction factor β(n) is updated into a value larger than the current value by the update unit 55. The “Cα” and “Cβ” are larger than 1.

On the other hand, when the total power P is smaller than the lower limit threshold AL, a predetermined value “Cα (>1)” is generated as an amount of change Δα, and a predetermined value “1/Cβ (<1)” is generated as an amount of change Δβ in step S15. In this case, the correction factor α(n) is updated into a value larger than the current value by the update unit 54, and the correction factor β(n) is updated into a value smaller than the current value by the update unit 55. The “Cα” and “Cβ” are larger than 1.

In step S16, the selected amounts of changes Δα and Δβ are transmitted to the arithmetic units 54 and 55.

Thus, in the correction factor generation unit 50 shown in FIG. 12, if the level of an input signal (in this example, the power of a branch signal) is in an appropriate range, the correction factor can be maintained as is. On the other hand, the correction factor is updated such that the reference signal r(n) is made smaller, and/or the sum Y(n) is made larger if it is determined that the level of an input signal is too high. If it is determined that the level of the input signal is too low, then the correction factor is updated such that the reference signal r(n) is made larger, and/or the sum Y(n) is made smaller.

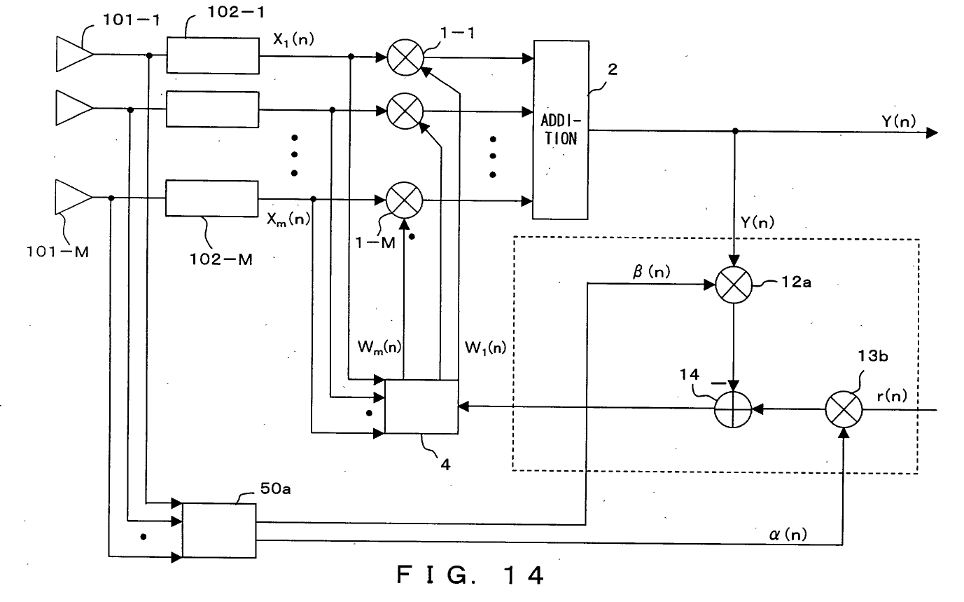

In the adaptive array receiver shown in FIG. 11, a correction factor is determined according to the signal (branch signals X1(n)˜Xm(n)) converted into digital data by the reception circuits 102-1˜102-M. However, as shown in FIG. 14, the correction factor can be determined according to the analog signal immediately after being received by the 1 antennas 101-1˜101-M. In this case, the analog signal received by the antennas 101-1˜101-M is branched to a correction factor generation unit 50a using an analog device (directional coupler, etc.) not shown in the attached drawings. The correction factor generation unit 50a has the function of detecting the amplitude level of an analog signal and converting it into a voltage data.

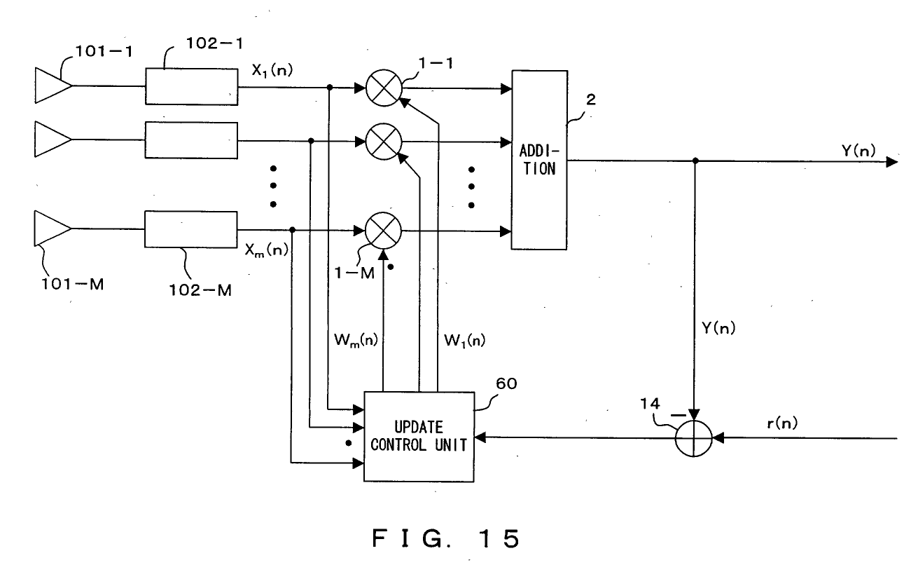

FIG. 15 shows the configuration of the adaptive array receiver according to another embodiment according to the present invention. This adaptive array receiver comprises an update control unit 60, and outputs an adaptive weight satisfying a reference value generated in the past without updating the adaptive weight when the adaptive weight or the power of the received signal does not satisfy a predetermined requirement, thereby preventing an inappropriate adaptive weight from being used, and suppressing the interference between users. The multipliers 1-1˜1-M, the adder 2, the subtracter 14, the antennas 101-1˜101-M, and the reception circuits 102-1˜102-M are the same as those described above.

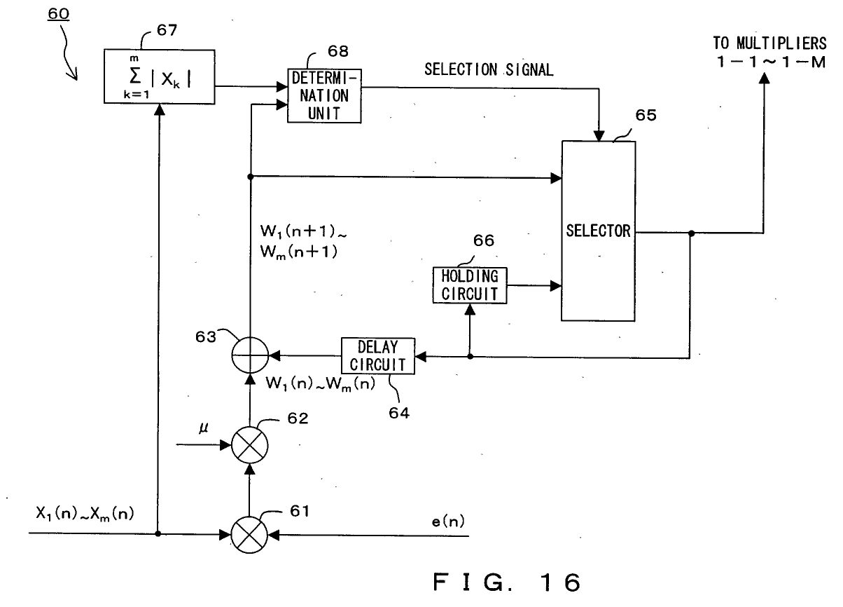

FIG. 16 shows an embodiment of the update control unit 60 shown in FIG. 15. The update control unit 60 generates the next adaptive weights W1(n+1)˜Wm(n+1) according to the error function e(n) computed by the subtracter 14, and the branch signals X1(n)˜Xm(n) before performing multiplication by the current adaptive weights W1(n)˜Wm(n).

A multiplier 61 multiplies each of the branch signals X1(n)˜Xm(n) by the error function e(n). A multiplier 62 multiplies the output of the multiplier 61 by a step constant μ. An adder 63 adds the output of a delay circuit 64 to the output of the multiplier 62. The output of the delay circuit 64 is the current adaptive weights W1(n)˜Wm(n) provided for the multipliers 1-1˜1-M, and corresponds to the first term of the right side of the equation (2) above. The output of the multiplier 62 corresponds to the second term of the right side of the equation (2) above. Therefore, the output of the adder 63 corresponds to the adaptive weights W1(n+1)˜Wm(n+1) to be output next. The adaptive weights W1(n+1)˜Wm(n+1) are provided for a selector 65.

The selector 65 selects a newly generated adaptive weights W1(n+1)˜Wm(n+1) or the adaptive weight held by a holding circuit 66, and outputs the selected adaptive weights. The adaptive weight selected by the selector 65 is provided for the multipliers 1-1˜1-M. At this time, the holding circuit 66 holds the current adaptive weights. That is to say, the selector 65 selects and outputs a newly generated adaptive weights or the previous adaptive weights according to the selection signal. Here, selecting and outputting the previous adaptive weights indicates that the adaptive weight is not updated.

A power detection unit 67 detects the total power of the branch signals X1(n)˜Xm(n). The method for detecting the total power is described above. The determination unit 68 generates a selection signal depending on whether the adaptive weights W1(n+1)˜Wm(n+1) to be output next satisfy a predetermined requirement, and whether the power of the input signal satisfies a predetermined requirement.

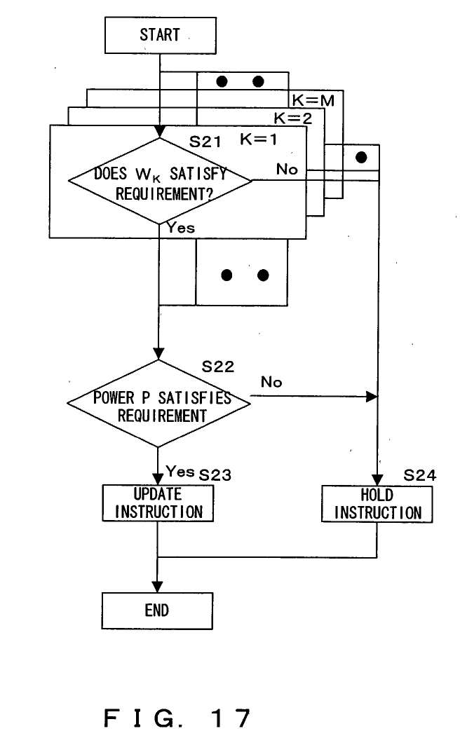

FIG. 17 is a flowchart of the operation of the determination unit 68.

In step S21, it is determined whether or not each of the adaptive weights W1(n+1)˜Wm(n+1) satisfies a predetermined requirement. For example, this requirement is defined as the range of amplitude of an adaptive weight, and can be obtained by a test, a simulation, etc.

When all adaptive weights W1(n+1)˜Wm(n+1) satisfy the above mentioned requirement, it is determined in step S22 whether or not the power P of the input signal has satisfied a predetermined requirement. The requirement is defined by the upper limit and the lower limit, and can be obtained by a test, a simulation, etc. If the power of an input signal satisfies the requirement, a selection signal indicating an update instruction is output in step S23. Upon receipt of the update instruction, the selector 65 selects and outputs the newly generated adaptive weights W1(n+1)˜Wm(n+1).

On the other hand, if the adaptive weights do not satisfy the requirement (NO in step S21), or if the power of an input signal does not satisfy the requirement (NO in step S22), then a selection signal indicating a hold instruction is output in step S24. Upon receipt of the hold instruction, the selector 65 selects and outputs the previous adaptive weights held in the holding circuit 66.

Thus, in the adaptive array receiver according to this embodiment, when a newly generated adaptive weight indicates an abnormal value or when it is predicted that it indicates an abnormal value, the new adaptive weight is not used, and an appropriate adaptive weight, which was previously used, is used again. Therefore, it is not likely to process an input signal using an inappropriate adaptive weight. Furthermore, when an algorithm is entering an unstable state without generating an appropriate adaptive weight although the reference signal r(n) or the sum Y(n) is multiplied by a correction factor, the update of the adaptive weight stops, thereby avoiding the problem. That is to say, the adaptive weight can be held in a stable area.

Since the operation of a feedback system for generating an adaptive weight is not stable immediately after the switching on or reset, an inappropriate adaptive weight is often generated. Therefore, this problem is to be taken into account with the determination unit 42 shown in FIG. 9, the determination unit 53 shown in FIG. 12, and the determination unit 68 shown in FIG. 16 during the period. In the embodiment below, an appropriate range (threshold) of an adaptive weight or a reception level is changed depending on an elapsed time from switching on or reset.

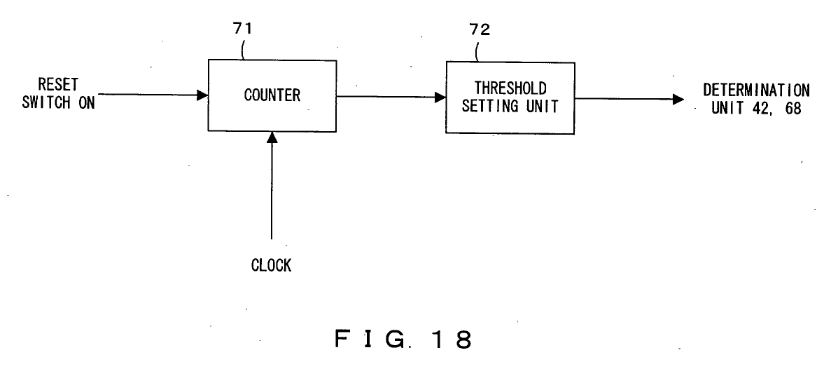

FIG. 18 shows the configuration of the function of setting an appropriate range of an adaptive weight or a reception level. A counter 71 receives a clock signal, and counts the elapsed time from the switching on (including reset). If a predetermined time has passed, the counter 71 transmits a switch signal to a threshold setting unit 72. Plural pieces of range information are set in the threshold setting unit 72. Each piece of range information defines an upper limit threshold and a lower limit threshold. For example, the range information to be provided for the determination unit 42 is defined by the upper limit threshold and the lower limit threshold of the amplitude of an adaptive weight. Upon receipt of the switch signal, the threshold setting unit 72 switches the range information to be output.

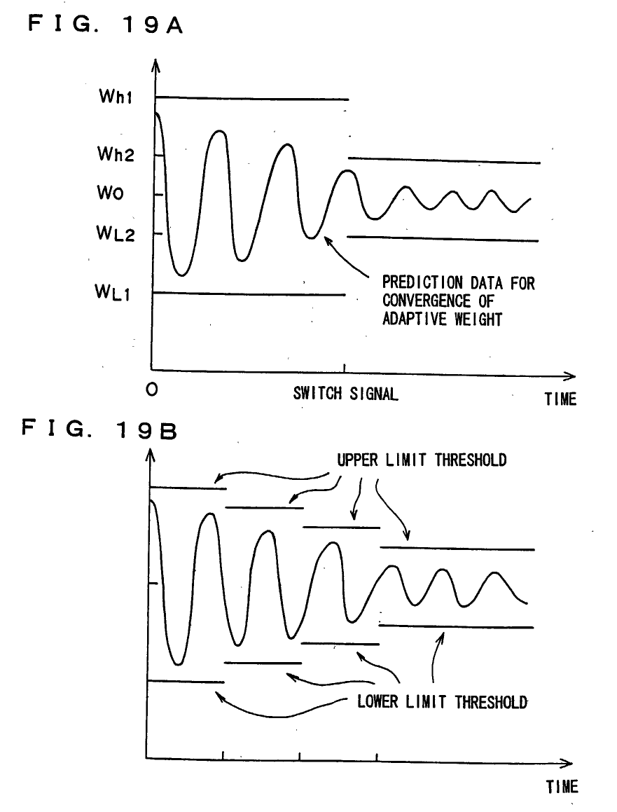

FIG. 19A shows a method for setting a threshold. In the example described below, a threshold for defining the appropriate range of an adaptive weight is set.

The threshold setting unit 72 sets a pair of thresholds for definition of a relatively broad appropriate range. In the example shown in FIG. 19A, an “upper limit threshold=Wh1” and a “lower limit threshold=WL1” are set. Upon receipt of a switch signal from the counter 71, the threshold setting unit 72 sets a pair of thresholds for definition of a relatively narrow appropriate range. In the example shown in FIG. 19A, an “upper limit threshold=Wh2” and a “lower limit threshold=WL2” are set.

In FIG. 19A, two appropriate ranges are prepared, but as shown in FIG. 19B, three or more appropriate ranges can be prepared, and the range can be gradually narrowed.

As described above, according to this embodiment, a broad appropriate range is set immediately after power is turned on (including reset). As a result, it is less frequently determined that an adaptive weight, etc. is out of an appropriate range immediately after switching on, thereby removing the execution of an unnecessary process, and shortening the convergence time of an adaptive weight. Furthermore, after a predetermined time has passed from switching on, a relatively narrow appropriate range is set, thereby holding an adaptive weight in a stable area.

Described below is the method for adjusting the timing of the sum Y(n) and the reference signal r(n).

In the minimum mean square error algorithm according to the present invention, a difference between the sum Y(n) and the reference signal r(n) is computed as described above, and the difference is used as an error function e(n). Then, using the error function e(n), an adaptive weight is generated. Therefore, if the timings of the sum Y(n) and the reference signal r(n) do not match each other, then no correct error functions e(n) can be generated, or no correct adaptive weights can be generated. As a result, the interference between users cannot be appropriately removed.

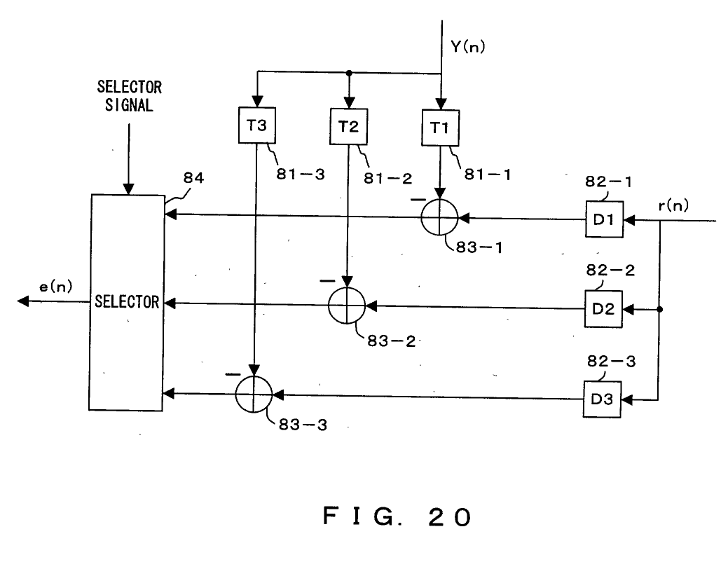

FIG. 20 shows the error function generating unit having the function of adjusting the timings of the sum Y(n) and the reference signal r(n). This error function generating unit comprises: delay circuits 81-1˜81-3 for holding the sum Y(n); delay circuits 82-1˜82-3 for holding the reference signal r(n); subtraction circuits 83-1˜83-3; and a selector 84. The delay time of the delay circuits 81-1˜81-3 and the delay circuits 82-1˜82-3 is individually set/updated by a control circuit not shown in the attached drawings. The subtracter 83-1 computes the difference between the output of the delay circuit 81-1 and the output of the delay circuit 82-1. The subtracter 83-2 computes the difference between the output of the delay circuit 81-2 and the output of the delay circuit 82-2. The subtracter 83-3 computes the difference between the output of the delay circuit 81-3 and the output of the delay circuit 82-3. The selector 84 selects one of the error functions output from the subtraction circuits 83-1˜83-3.

A selector signal is determined as follows. That is, first, the selector 84 sequentially selects error functions output from the subtraction circuits 83-1˜83-3. Then, the control circuit monitors the convergence of an adaptive weight in each case. As a result, the selector signal is determined such that the selector 84 can select the error function indicating the optimum convergence.

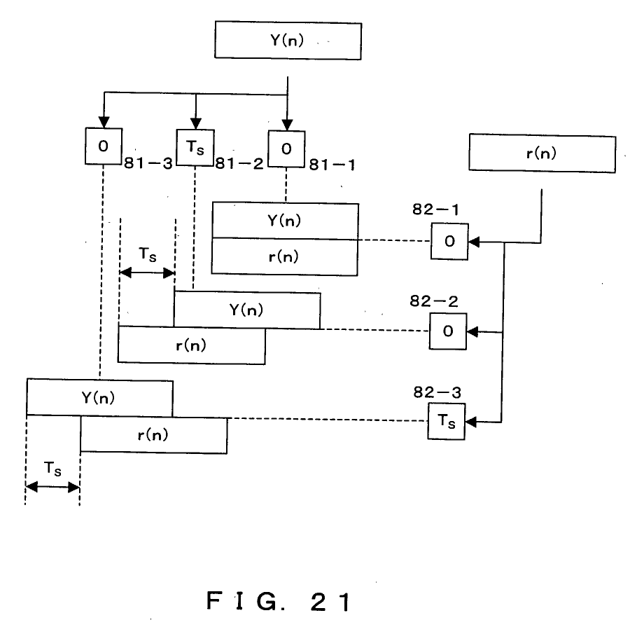

In the initial state, as shown in FIG. 21, the delay times set in the delay circuits 81-1˜81-3 are 0(zero), Ts, and 0(zero) respectively, and the delay times set in the delay circuits 82-1˜82-3 are 0(zero), 0(zero), and Ts respectively. The “Ts” is a unit time, and can be, for example, the period of a system lock.

If the timings of the sum Y(n) and the reference signal r(n) completely match in this state, the output of the delay circuit 81-1 with the delay time of 0 matches in timing the output of the delay circuit 82-1 with the delay time of 0 as shown in FIG. 21. On the other hand, the output of the delay circuits 81-2 and 82-2 indicate a delay of the sum Y(n) by the time of Ts, and the output of the delay circuits 81-3 and 82-3 indicate a delay of the reference signal r(n) by the time of Ts. In this case, if error function e(n) are generated for these three patterns, and an adaptive weight is generated for each of the error functions e(n), then the adaptive weight used when the error function e(n) generated from the output of the delay circuits 81-1 and 82-1 is used is to optimally converge. That is to say, in this case, the selector 84 selects the error function e(n) generated from the output of the delay circuits 81-1 and 82-1.

Thus, the error function generating unit shown in FIG. 20 provides a state in which the sum Y(n) is delayed by the time of Ts using the delay circuits 81-2 and 82-2, and a state in which the reference signal r(n) is delayed by the time of Ts using the delay circuits 81-3 and 82-3, with reference to the timing generated using the delay circuits 81-1 and 82-1. Then, by checking the convergence state, etc. of an adaptive weight for these three patterns, the timings of the sum Y(n) and the reference signal r(n) are adjusted.

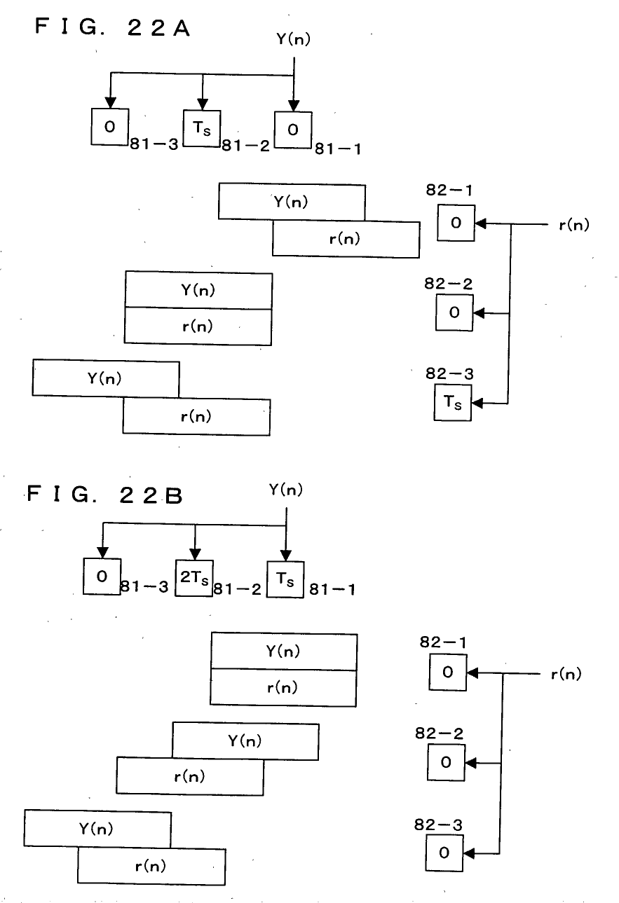

However, it is difficult that the timings of the sum Y(n) and the reference signal r(n) can completely match each other. Therefore, for example, as shown in FIG. 22A, the timings of the sum Y(n) and reference signal r(n) are match each other in the output of the delay circuits 81-2 and 82-2. In this case, if an adaptive weight is generated for each of the error functions e(n) computed by the subtraction circuits 83-1˜83-3, then the adaptive weight corresponding to the error function e(n) output from the subtracter 83-2 is to optimally converge. That is to say, in this case, the selector 84 selects the error function e(n) from the subtracter 83-2.

Thus, when the timings of the sum Y(n) and the reference signal r(n) do not match each other, the timings are adjusted by the delay circuits 81-1˜81-3 and 82-1˜82-3. At this time, the delay values of the delay circuits 81-1˜81-3 and 82-1˜82-3 are set again such that the selector 84 will select the output of the subtracter 83-1. Practically, as shown in FIG. 22B, Ts, 2Ts, and 0(zero) are set in the delay circuits 81-1, 81-2 and 81-3 respectively, and 0(zero) is set in each of the delay circuits 82-1˜82-3. Thus, when the output of the subtracter 83-1 is defined as a reference, a state where the sum Y(n) is delayed by the time of Ts is obtained at the output of the subtracter 83-2, and a state where the reference signal r(n) is delayed by the time of Ts is obtained at the output of the subtracter 83-3. The position of the reference subtracter is shown as an example, and is not limited to this position.

On the other hand, if the timings of the sum Y(n) and the reference signal r(n) of the output of the delay circuits 81-3 and 82-3 match each other when the delay values shown in FIG. 21 are set for the delay circuits 81-1˜81-3 and 82-1˜82-3, then 0(zero) is set in each of the delay circuits 81-1 81-3, and Ts, 0(zero), and 2Ts are set respectively in the delay circuits 82-1, 82-2, and 82-3.

With the above mentioned configuration, the timings of the sum Y(n) and the reference signal r(n) are automatically optimized, and the minimum mean square error algorithm can be corrected to ensure constant stability.

According to the present invention, a device for processing a signal using the minimum mean square error algorithm, a stable value of an adaptive weight by which an input signal is multiplied can be ensured. Therefore, if the present invention is applied to an adaptive array receiver or a calibrator, the reliability and robustness in wireless communications can be improved. Especially, in the wireless communications system, the interference between users can be suppressed.

What is claimed is:

1. An apparatus for processing a signal using an minimum mean square error algorithm, comprising:
an error function generation unit generating an error function which indicates a difference between an output signal obtained by multiplying an input signal by an adaptive weight and a reference signal;
a weight generation unit generating the adaptive weight based on an error function generated by said error function generation unit; and
a correction unit correcting at least one of the output signal and the reference signal.

2. The apparatus according to claim 1, wherein
said correction unit corrects both of the output signal and the reference signal.

3. The apparatus according to claim 1, wherein
said correction unit generates a correction factor for correcting the output signal or the reference signal based on the adaptive weight generated by said weight generation unit.

4. The apparatus according to claim 1, further comprising
a setting unit setting an upper limit threshold of the adaptive weight; wherein
said correction unit performs at least one of a process of raising a level of the output signal and a process of lowering a level of the reference signal, when the adaptive weight generated by said weight generation unit is larger than the upper limit threshold.

5. The apparatus according to claim 1, further comprising
a setting unit setting a lower limit threshold of the adaptive weight; wherein
said correction unit performs at least one of a process of lowering a level of the output signal and a process of raising a level of the reference signal, when the adaptive weight generated by said weight generation unit is smaller than the lower limit threshold.

6. The apparatus according to claim 1, wherein
said correction unit generates a correction factor for correcting the output signal or the reference signal based on the level of the input signal.

7. The apparatus according to claim 1, further comprising
a setting unit setting an upper limit threshold of a level of the input signal, wherein
said correction unit performs at least one of a process of raising a level of the output signal and a process of lowering a level of the reference signal, when the level of the input signal is higher than the upper limit threshold.

8. The apparatus according to claim 1, further comprising
a setting unit setting a lower limit threshold of a level of the input signal, wherein
said correction unit performs at least one of a process of lowering a level of the output signal and a process of raising a level of the reference signal, when the level of the input signal is lower than the lower limit threshold.

9. The apparatus according to claim 4, wherein
said setting unit sets a first upper limit threshold immediately after switching on or reset, and sets a second upper limit threshold lower than the first upper limit threshold when a predetermined time period elapses from the switching on or reset.

10. The apparatus according to claim 5, wherein
said setting unit sets a first lower limit threshold immediately after switching on or reset, and sets a second lower limit threshold higher than the first lower limit threshold when a predetermined time period elapses from the switching on or reset.

11. An apparatus for processing a signal using an minimum mean square error algorithm, comprising:
an error function generation unit generating an error function which indicates a difference between an output signal obtained by multiplying an input signal by an adaptive weight and a reference signal;
a weight generation unit generating the adaptive weight based on an error function generated by said error function generation unit;
a holding unit holding an adaptive weight by which the input signal is multiplied;
a determination unit determining whether the adaptive weight generated by said weight generation unit satisfies a predetermined requirement; and
a selection unit outputting a newly generated adaptive weight for multiply with a next input signal when the adaptive weight newly generated by said weight generation unit satisfies the requirement, and outputting the adaptive weight held by said holding unit for multiply with the next input signal when the adaptive weight newly generated by said weight generation unit does not satisfy the requirement.

12. An apparatus for processing a signal using an minimum mean square error algorithm, comprising:
an error function generation unit generating an error function which indicates a difference between an output signal obtained by multiplying an input signal by an adaptive weight and a reference signal;
a weight generation unit generating the adaptive weight based on an error function generated by said error function generation unit;
a holding unit holding an adaptive weight by which the input signal is multiplied;
a determination unit determining whether a level of the input signal satisfies a predetermined requirement; and
a selection unit outputting a adaptive weight newly generated by said weight generation unit for multiply with a next input signal when the level of the input signal satisfies the requirement, and outputting the adaptive weight held by said holding unit for multiply with the next input signal when the level of the input signal does not satisfy the requirement.

13. An apparatus for processing a signal using an minimum mean square error algorithm, comprising:
an error function generation unit generating an error function which indicates a difference between an output signal obtained by multiplying an input signal by an adaptive weight and a reference signal;
a weight generation unit generating the adaptive weight based on an error function generated by said error function generation unit; and
a adjustment unit adjusting input timings of the output signal and the reference signal into said error function generation unit such that the adaptive weight generated by said weight generation unit is optimized.

14. An adaptive array receiver for processing a signal using a minimum mean square error algorithm, comprising:
a plurality of antennas;
a plurality of multipliers multiplying a plurality of branch signals received through said plurality of antennas by respective adaptive weights;
an error function generation unit generating an error function indicating a difference between a sum of a plurality of output signals output from the plurality of multipliers and a reference signal;
a weight generation unit generating the adaptive weight based on the error function generated by said error function generation unit; and
a correction unit correcting at least one of the sum and the reference signal.

15. A base station apparatus having an adaptive array receiver for receiving a radio signal in a wireless communications system, said adaptive array receiver comprising:
a plurality of antennas;
a plurality of multipliers multiplying a plurality of branch signals received through said plurality of antennas by respective adaptive weights;
an error function generation unit generating an error function indicating a difference between a sum of a plurality of output signals output from the plurality of multipliers and a reference signal;
a weight generation unit generating the adaptive weight based on the error function generated by said error function generation unit; and
a correction unit correcting at least one of the sum and the reference signal.

16. A method for processing a signal using an minimum mean square error algorithm, comprising:
generating an error function which indicates a difference between an output signal obtained by multiplying an input signal by an adaptive weight and a reference signal;
generating the adaptive weight based on the error function; and
correcting at least one of the output signal and the reference signal, when the error function is generated.

17. An apparatus for processing a signal using an minimum mean square error algorithm, comprising:
error function generating means for generating an error function which indicates a difference between an output signal obtained by multiplying an input signal by an adaptive weight and a reference signal;
weight generating means for generating the adaptive weight based on an error function generated by said error function generation means; and
correcting means for correcting at least one of the output signal and the reference signal.
